(19) United States
(12) Patent Application Publication
(10) Pub. No.: US 2024/0311274 A1
(43) Pub. Date: Sep. 19, 2024

(54) METHOD AND SYSTEM FOR AUTOMATED PREDICTION OF CODE RISKINESS

(71) Applicant: JPMorgan Chase Bank, N.A., New York, NY (US)

(72) Inventors: Rares DOLGA, London (GB); Meshaal KIRMANI, Middlesex (GB); Yulong PEI, London (GB); Mehtab PATHAN, London (GB); Salwa Husam ALAMIR, Bournemouth (GB); Jonathan BUDD, London (GB); Wided OUAJA, London (GB); Sameena SHAH, Scarsdale, NY (US); Matteo CASSIA, London (GB); Krzysztof CIBA, Middlesex (GB); Wojciech KOKOT, London (GB); James BURROW, Shoreham By Sea (GB)

(73) Assignee: JPMorgan Chase Bank, N.A., New York, NY (US)

(21) Appl. No.: 18/121,287

(22) Filed: Mar. 14, 2023

(51) Int. Cl. G06F 11/36

(52) U.S. Cl. CPC G06F 11/3612

(57) ABSTRACT

A method and a system for applying a machine learning model that uses an artificial intelligence technique to determine that a software code commit is risky and therefore likely to result in a production issue and to provide an explanation for the risk are provided. The method includes: receiving a first code commit; analyzing the first code commit in order to determine features that relate to the first code commit; applying a machine learning model that uses an artificial intelligence technique to project a result of executing the first code commit; assessing whether the first code commit is risky based on an output of the machine learning model; and when the first code commit is assessed as being risky, determining an explanation that relates to the assessment.

### BACKGROUND

### 1. Field of the Disclosure

This technology generally relates to methods and systems for predicting software code production issues, and more particularly to methods and systems for applying a machine learning model that uses an artificial intelligence technique to determine that a software code commit is risky and therefore likely to result in a production issue and to provide an explanation for the risk.

### 2. Background Information

Typically, in the case of a software code production issue, there are two ways to resolve such an issue. The first way is by fixing forward; i.e., adding new code on top of the old code in order to fix the issue. The second way is to roll back, which means to revert back to the last working version of the code. In the cases where the issue is critical and the resolution is time-critical, rolling back is the first approach and after a root cause analysis a fix forward can be implemented. Thus, any code commit that ultimately results in either of a fix-forward and/or a revert may be understood as being a risky commit.

Accordingly, there is a need for a method for applying a machine learning model that uses an artificial intelligence technique to determine that a software code commit is risky and therefore likely to result in a production issue and to provide an explanation for the risk.

### SUMMARY

The present disclosure, through one or more of its various aspects, embodiments, and/or specific features or sub-components, provides, inter alia, various systems, servers, devices, methods, media, programs, and platforms for applying a machine learning model that uses an artificial intelligence technique to determine that a software code commit is risky and therefore likely to result in a production issue and to provide an explanation for the risk.

According to an aspect of the present disclosure, a method for predicting a risky code commit is provided. The method is implemented by at least one processor. The method includes: receiving, by the at least one processor, a first code commit; analyzing, by the at least one processor, the first code commit in order to determine a plurality of features that relate to the first code commit; applying, by the at least one processor, a machine learning model that uses an artificial intelligence technique to project a result of executing the first code commit; assessing, by the at least one processor based on a result of the applying, whether the first code commit is risky; and when the first code commit is assessed as being risky, determining an explanation that relates to the assessment of riskiness.

The assessing of whether the first code commit is risky may include detecting an anomaly with respect to at least one feature from among the plurality of features based on a result of the applying of the machine learning model.

The assessing of whether the first code commit is risky may further include calculating, for each respective feature from among the plurality of features, a corresponding ranking value, and detecting the anomaly based on each corresponding ranking value.

The calculating of each corresponding ranking value may include calculating a Shapley Additive explanations (SHAP) value of each respective feature from among the plurality of features.

The method may further include displaying, via a user interface (UI), a textual message that includes the explanation.

The textual message may further include at least one recommendation for performing an action in order to overcome the assessed riskiness.

The method may further include displaying, via the UI, a first button for prompting a user to abort the first code commit and a second button for prompting the user to confirm the first code commit.

When the user confirms the first code commit, the method may further include prompting the user to input a justification for confirming the first code commit.

The plurality of features may include at least one from among a number of lines of code, a number of files being changed, a number of first modules importing second modules being changed, a time interval between making the first code commit and progressing into production, a cyclomatic complexity, a number of times that the second modules have been reverted in a most recent 30-day period, a version of the second modules, and a number of developers who have contributed changes to the second modules.

According to another exemplary embodiment, a computing apparatus for predicting a risky code commit is provided. The computing apparatus includes a processor; a memory; a display; and a communication interface coupled to each of the processor, the memory, and the display. The processor is configured to: receive, via the communication interface, a first code commit; analyze the first code commit in order to determine a plurality of features that relate to the first code commit; apply a machine learning model that uses an artificial intelligence technique to project a result of executing the first code commit; assess, based on a result of the application of the machine learning model, whether the first code commit is risky; and when the first code commit is assessed as being risky, determine an explanation that relates to the assessment of riskiness.

The processor may be further configured to perform the assessment of whether the first code commit is risky by detecting an anomaly with respect to at least one feature from among the plurality of features based on a result of the applying of the machine learning model.

The processor may be further configured to perform the assessment of whether the first code commit is risky by calculating, for each respective feature from among the plurality of features, a corresponding ranking value, and detecting the anomaly based on each corresponding ranking value.

The processor may be further configured to perform the calculation of each corresponding ranking value by calculating a Shapley Additive explanations (SHAP) value of each respective feature from among the plurality of features.

The processor may be further configured to cause the display to display, via a user interface (UI), a textual message that includes the explanation.

The textual message may further include at least one recommendation for performing an action in order to overcome the assessed riskiness.

The processor may be further configured to cause the display to display, via the UI, a first button for prompting a user to abort the first code commit and a second button for prompting the user to confirm the first code commit.

When the user confirms the first code commit, the processor may be further configured to prompt the user to input a justification for confirming the first code commit.

The plurality of features may include at least one from among a number of lines of code, a number of files being changed, a number of first modules importing second modules being changed, a time interval between making the first code commit and progressing into production, a cyclomatic complexity, a number of times that the second modules have been reverted in a most recent 30-day period, a version of the second modules, and a number of developers who have contributed changes to the second modules.

According to yet another exemplary embodiment, a non-transitory computer readable storage medium storing instructions for predicting a risky code commit is provided. The storage medium includes executable code which, when executed by a processor, causes the processor to: receive a first code commit; analyze the first code commit in order to determine a plurality of features that relate to the first code commit; apply a machine learning model that uses an artificial intelligence technique to project a result of executing the first code commit; assess, based on a result of the application of the machine learning model, whether the first code commit is risky; and when the first code commit is assessed as being risky, determine an explanation that relates to the assessment of riskiness.

When executed by the processor, the executable code may further cause the processor to perform the assessment of whether the first code commit is risky by detecting an anomaly with respect to at least one feature from among the plurality of features based on a result of the applying of the machine learning model.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for applying a machine learning model that uses an artificial intelligence technique to determine that a software code commit is risky and therefore likely to result in a production issue and to provide an explanation for the risk.

FIG. 4 is a flowchart of an exemplary process for implementing a method for applying a machine learning model that uses an artificial intelligence technique to determine that a software code commit is risky and therefore likely to result in a production issue and to provide an explanation for the risk.

FIG. 5 is a system work flow diagram that illustrates an execution of a method for applying a machine learning model that uses an artificial intelligence technique to determine that a software code commit is risky and therefore likely to result in a production issue and to provide an explanation for the risk, according to an exemplary embodiment.

FIG. 6 is a screenshot of a user interface of a system that implements a method for applying a machine learning model that uses an artificial intelligence technique to determine that a software code commit is risky and therefore likely to result in a production issue and to provide an explanation for the risk, according to an exemplary embodiment.

FIG. 7 is a diagram that illustrates a set of potential results of monitoring a method for applying a machine learning model that uses an artificial intelligence technique to determine that a software code commit is risky and therefore likely to result in a production issue and to provide an explanation for the risk, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

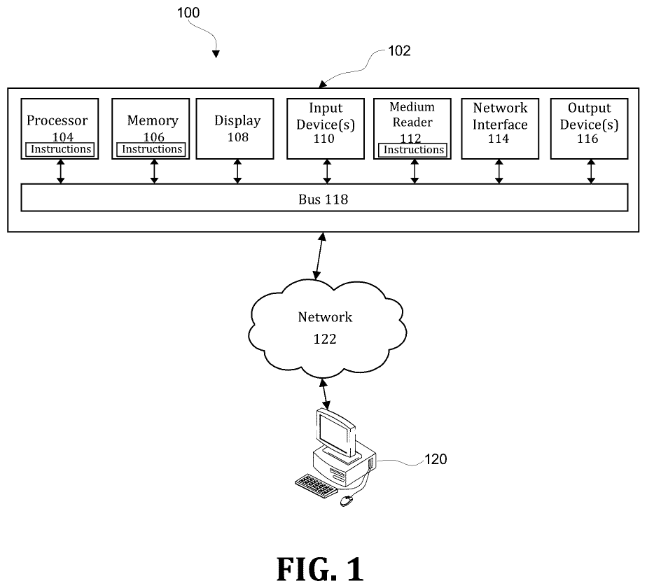

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for applying a machine learning model that uses an artificial intelligence technique to determine that a software code commit is risky and therefore likely to result in a production issue and to provide an explanation for the risk. In the present disclosure, the terms “machine learning” and “artificial intelligence” may be used interchangeably. Further, the term “statistical learning” may also be used to refer to the use of statistical analysis in conjunction with machine learning and/or artificial intelligence techniques.

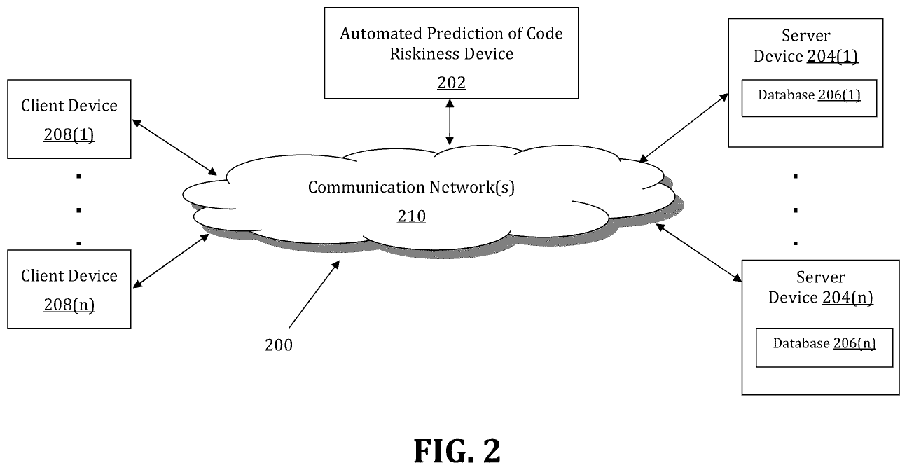

Referring to FIG. 2, a schematic of an exemplary network environment 200 for implementing a method for applying a machine learning model that uses an artificial intelligence technique to determine that a software code commit is risky and therefore likely to result in a production issue and to provide an explanation for the risk is illustrated. In an exemplary embodiment, the method is executable on any networked computer platform, such as, for example, a personal computer (PC).

The method for applying a machine learning model that uses an artificial intelligence technique to determine that a software code commit is risky and therefore likely to result in a production issue and to provide an explanation for the risk may be implemented by an Automated Prediction of Code Riskiness (APCR) device 202. The APCR device 202 may be the same or similar to the computer system 102 as described with respect to FIG. 1. The APCR device 202 may store one or more applications that can include executable instructions that, when executed by the APCR device 202, cause the APCR device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the APCR device 202 itself, may be located in virtual server(s) running in a cloud-based computing environment rather than being tied to one or more specific physical network computing devices. Also, the application(s) may be running in one or more virtual machines (VMs) executing on the APCR device 202. Additionally, in one or more embodiments of this technology, virtual machine(s) running on the APCR device 202 may be managed or supervised by a hypervisor.

In the network environment 200 of FIG. 2, the APCR device 202 is coupled to a plurality of server devices 204(1)-204(n) that hosts a plurality of databases 206(1)-206(n), and also to a plurality of client devices 208(1)-208(n) via communication network(s) 210. A communication interface of the APCR device 202, such as the network interface 114 of the computer system 102 of FIG. 1, operatively couples and communicates between the APCR device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the APCR device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and APCR devices that efficiently implement a method for applying a machine learning model that uses an artificial intelligence technique to determine that a software code commit is risky and therefore likely to result in a production issue and to provide an explanation for the risk.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The APCR device 202 may be a standalone device or integrated with one or more other devices or apparatuses, such as one or more of the server devices 204(1)-204(n), for example. In one particular example, the APCR device 202 may include or be hosted by one of the server devices 204(1)-204(n), and other arrangements are also possible. Moreover, one or more of the devices of the APCR device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the APCR device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to historical code commits and information that relates to statistics and analytical metrics that relate to monitoring code commit results.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the APCR device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the APCR device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the APCR device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the APCR device 202, the server devices 204(1)-204(n), or the client devices 208(1)-208(n), for example, may be configured to operate as virtual instances on the same physical machine. In other words, one or more of the APCR device 202, the server devices 204(1)-204(n), or the client devices 208(1)-208(n) may operate on the same physical device rather than as separate devices communicating through communication network(s) 210. Additionally, there may be more or fewer APCR devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

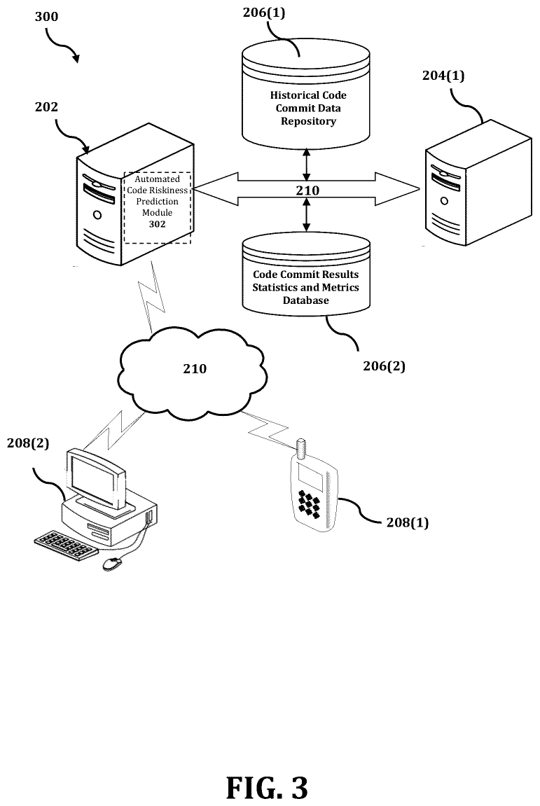

The APCR device 202 is described and illustrated in FIG. 3 as including an automated code riskiness prediction module 302, although it may include other rules, policies, modules, databases, or applications, for example. As will be described below, the automated code riskiness prediction module 302 is configured to implement a method for applying a machine learning model that uses an artificial intelligence technique to determine that a software code commit is risky and therefore likely to result in a production issue and to provide an explanation for the risk.

An exemplary process 300 for implementing a mechanism for applying a machine learning model that uses an artificial intelligence technique to determine that a software code commit is risky and therefore likely to result in a production issue and to provide an explanation for the risk by utilizing the network environment of FIG. 2 is illustrated as being executed in FIG. 3. Specifically, a first client device 208(1) and a second client device 208(2) are illustrated as being in communication with APCR device 202. In this regard, the first client device 208(1) and the second client device 208(2) may be “clients” of the APCR device 202 and are described herein as such. Nevertheless, it is to be known and understood that the first client device 208(1) and/or the second client device 208(2) need not necessarily be “clients” of the APCR device 202, or any entity described in association therewith herein. Any additional or alternative relationship may exist between either or both of the first client device 208(1) and the second client device 208(2) and the APCR device 202, or no relationship may exist.

Further, APCR device 202 is illustrated as being able to access a historical code commit data repository 206(1) and a code commit results statistics and metrics database 206(2). The automated code riskiness prediction module 302 may be configured to access these databases for implementing a method for applying a machine learning model that uses an artificial intelligence technique to determine that a software code commit is risky and therefore likely to result in a production issue and to provide an explanation for the risk.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the APCR device 202 via broadband or cellular communication. Of course, these embodiments are merely exemplary and are not limiting or exhaustive.

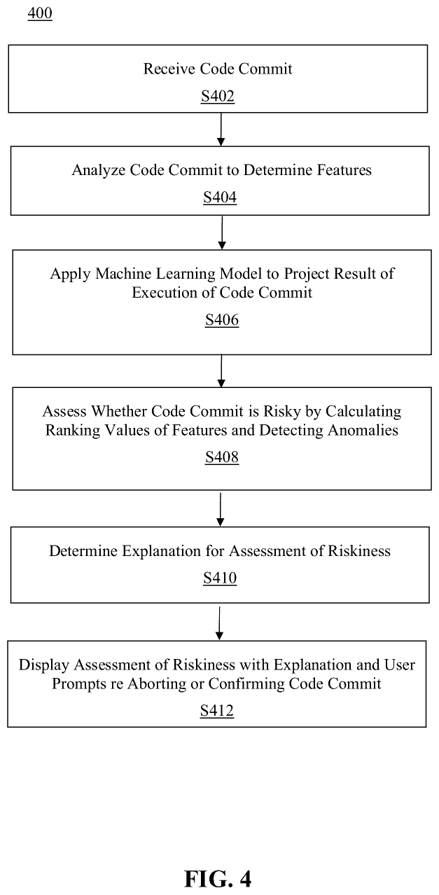

Upon being started, the automated code riskiness prediction module 302 executes a process for applying a machine learning model that uses an artificial intelligence technique to determine that a software code commit is risky and therefore likely to result in a production issue and to provide an explanation for the risk. An exemplary process for applying a machine learning model that uses an artificial intelligence technique to determine that a software code commit is risky and therefore likely to result in a production issue and to provide an explanation for the risk is generally indicated at flowchart 400 in FIG. 4.

In process 400 of FIG. 4, at step S402, the automated code riskiness prediction module 302 receives a code commit from a software developer. Then, at step S404, the automated code riskiness prediction module 302 analyzes the code commit to determine features of the code commit that are usable for evaluating a likelihood that there may be production issues associated with the code commit. Such features may include any one or more of the following: a number of lines of code associated with the code commit, a number of files being changed as a result of the code commit, a number of modules that are importing software modules that are being changed as a result of the code commit, a time interval between making the code commit and progressing into production, a cyclomatic complexity of the code commit, a number of times that the software modules that are being changed have been reverted in a most recent 30-day period, a version of the software modules that are being changed, and a number of developers who have contributed changes to the software modules that are being changed.

At step S406, the automated code riskiness prediction module 302 applies a machine learning model that uses an artificial intelligence technique to project a result of executing the code commit. In an exemplary embodiment, the machine learning model is trained by using historical data that relates to the code commit and other software modules that have been developed and utilized in connection with the code commit.

At step S408, the automated code riskiness prediction module 302 assesses whether or not the code commit is risky based on a result of the application of the machine learning model performed in step S406. In an exemplary embodiment, the assessment may be performed by calculating respective ranking values for the features identified in step S404, and then using those calculated values to detect an anomaly, or more than one anomaly, with respect to the features. In an exemplary embodiment, the ranking values may be calculated by calculating a Shapley Additive explanations (SHAP) value of each respective feature.

At step S410, when the code commit has been determined as being risky as a result of the assessment performed in step S408, the automated code riskiness prediction module 302 determines an explanation for the assessment of riskiness. Then, at step S412, the automated code riskiness prediction module 302 may include the explanation within a textual message that is displayable via a user interface (UI) so that a user, such as a developer that is associated with the code commit, is able to understand the reasons for the assessment of riskiness. In an exemplary embodiment, the textual message may further include one or more recommendations for performing an action in order to overcome the assessment of riskiness. In an exemplary embodiment, the UI may also display buttons that prompt the user to either abort the code commit or confirm the code commit, and/or to request further review or approval. In addition, when the user confirms the code commit, thereby effectively overriding the assessment of riskiness, the UI may also prompt the user to input a justification for the confirmation of the code commit.

In an exemplary embodiment, artificial intelligence (AI) and other automated techniques are used to predict if a code commit is deemed risky. The methodology is implemented by using an application that is able to learn what a risky code commit looks like from historical code commits and therefore predict if a commit will cause an issue and result in a revert. This application uses information that relates to the code commit itself, the file that was committed to by virtue of the code commit, and the experience of the developer. When a prediction is made that the code commit is deemed as being risky, the application is then able to notify the developer that 1) the code is deemed as being risky; and 2) an explanation as to one or more reasons why the code is deemed as being risky.

This requires the introduction of explainable AI into a model used by the application. In an exemplary embodiment, the model determines a set of features that are associated with the code commit, and the explanation explains which features were used to make the decision as to why a piece of code is deemed as being risky. The developer is then able to decide whether or not to change the piece of code or override the prompt and execute the code commit regardless of the assessment of riskiness. This user prompt is monitored in order to assess whether or not the model is able to accurately predict a revert in a live production environment.

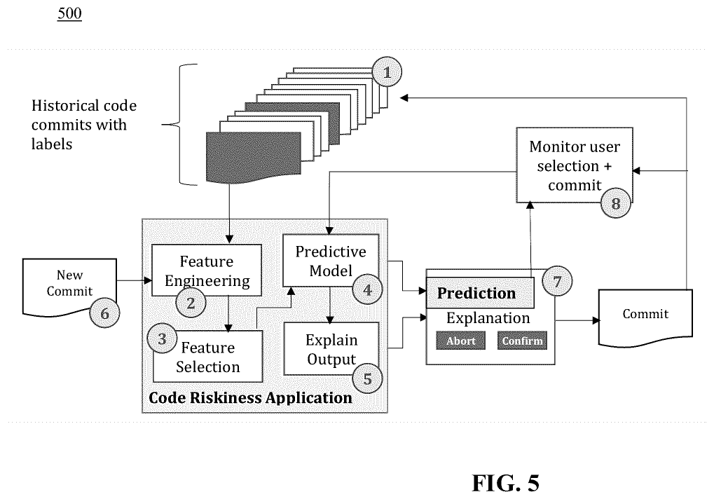

FIG. 5 is a system work flow diagram 500 that illustrates an execution of a method for applying a machine learning model that uses an artificial intelligence technique to determine that a software code commit is risky and therefore likely to result in a production issue and to provide an explanation for the risk, according to an exemplary embodiment. As illustrated in work flow diagram 500, in operation 1, a set of historical code commits are provided as an input to a code riskiness application, which includes a feature engineering component 2, a feature selection component 3, a predictive model 4, and an explain output component 5. The historical code commits are used to train the predictive model 4 and also as a resource for the feature engineering component 2 for identifying features that are usable for assessing whether a particular code commit is risky.

In operation 6, a new code commit is introduced as an input to the code riskiness application, which uses the feature engineering component 2 and the feature selection component 3 to identify features of the new commit, and also uses the predictive model 4 to perform the assessment of riskiness, and to make a corresponding prediction. When the code commit is deemed as being risky, the explain output component 5 generates an explanation for this assessment. In operation 7, the prediction and the explanation are provided to a user, such as, for example, a developer, and the user/developer is also provided with buttons for either aborting the code commit or confirming the code commit. Finally, in operation 8, the system monitors the user selection and the code commit itself, and feeds results of the monitoring operation into the code riskiness application.

In an exemplary embodiment, all code commits that have occurred over the last few years are stored in a memory, such as, for example, historical code commit data repository 206(1). This archive of data is very useful for training a machine learning model. Furthermore, other metadata that relates to each commit is available, such as the committer, the file committed to, the number of lines of code committed, and even test coverage results. In an exemplary embodiment, the key piece of information that is required with respect to the present inventive concept is whether or not a code commit was reverted, and this information is available. As a result, a very large dataset that is already labeled for training is available.

Feature engineering: In an exemplary embodiment, the number of features available for the model is quite large, and it is therefore important to select the features that are most useful for the riskiness assessment. Further, additional features that are not generally available in the raw data may also be identified. In an exemplary embodiment, this may be done by bucketing the continuous features in order to create discrete features. For instance, rather than using the number of lines of code, a customized feature may be created, such as number of lines greater than 100, or greater than 1000, and then a yes or no for each code commit as to whether or not the code commit fits in a particular bucket may be provided. In addition, features may be transformed and/or combined. Feature transformations may include, for example, applications of functions such as logarithmic functions or a square root function. Feature combinations may include, for example, a ratio of reverts to pushes.

The following is a list of exemplary features that may be used to train the model: 1) File version; 2) Number of unique contributors (committers); 3) Number of dependent modules; 4) Total cyclomatic complexity; 5) Revert frequency within the last 30 days; 6) Total lines of code in push set; 7) Number of files in push set; and 8) Commit to push lag days.

Predictive Model: In an exemplary embodiment, a number of models may be used to perform the prediction. It is important to note that less than 1% of code commits are reverted, and the number of code commits is in the order of thousands. This means that the model is handling an imbalanced classification problem. Additionally, there is a constraint of providing an explanation to the end user as to which features contribute to the prediction. This makes using deep learning models a challenge, as they are not very interpretable.

In an exemplary embodiment, a logistic regression model or other supervised learning technique may be used. The logistic regression model is able to predict whether or not a code commit is risky and prompt the user with a corresponding explanation. However, despite accounting for class imbalance, the performance is still low; especially the recall. In order to address this issue, the problem may be treated as an anomaly detection problem where there is an attempt to predict all reverts as an anomaly. For implementation, the isolation forest algorithm may be used. The isolation forest algorithm is an unsupervised learning technique that demonstrates improved recall over the logistic regression model. With this approach, the end user may be provided with the tree and conditions to move down a particular branch.

Explain Output: In an exemplary embodiment, it is pivotal to explain to the end user why their code commit is risky such that they can make appropriate changes to avoid downstream issues. One method for explainability is to use Shapley values. The Shapley tree explainer may be employed in order to explain the features, with importance, that are used in the decision for predicting whether or not a code commit is an anomaly. The explainer returns a local explanation, meaning it is typically used to explain a single prediction rather than the general model. The explanation can differ from one code commit to another.

New Code Commit: After the model is trained and put into production, the workflow is able to receive a new code commit, and perform feature engineering and predict whether or not the new code commit is an anomaly, i.e., deemed as being risky. In an exemplary embodiment, this system works real-time, providing a prompt to users as soon as they make a code commit. Prediction and explainability times are on the order of milliseconds.

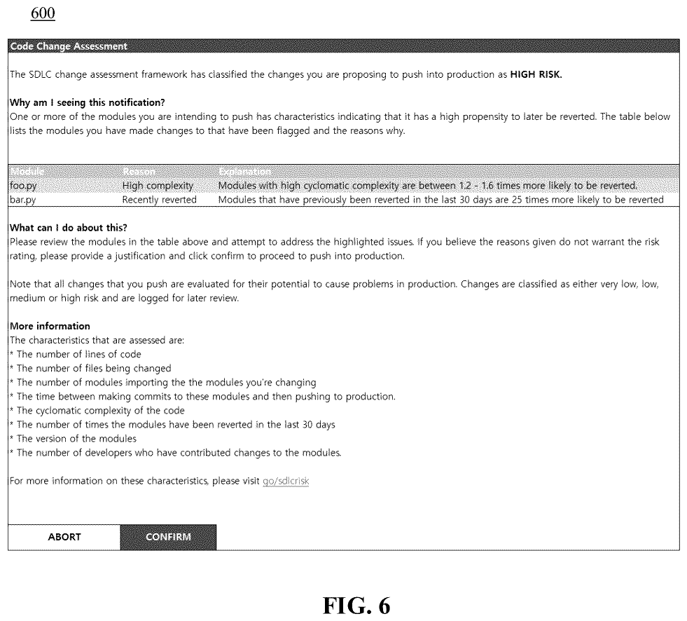

User Prompt: FIG. 6 is a screenshot 600 of a user interface of a system that implements a method for applying a machine learning model that uses an artificial intelligence technique to determine that a software code commit is risky and therefore likely to result in a production issue and to provide an explanation for the risk, according to an exemplary embodiment. The screenshot 600 shows an example prompt that may be received by an end user after making a code commit.

The user is then able to confirm in order to override the prompt and make a code commit regardless, or abort and make the appropriate changes to the commit before recommitting. In an exemplary embodiment, if the user decides to make a change to the code commit and re-commit, this is treated as a brand new commit that goes through the entire workflow of the model again in order to predict whether or not the new code commit will cause an issue.

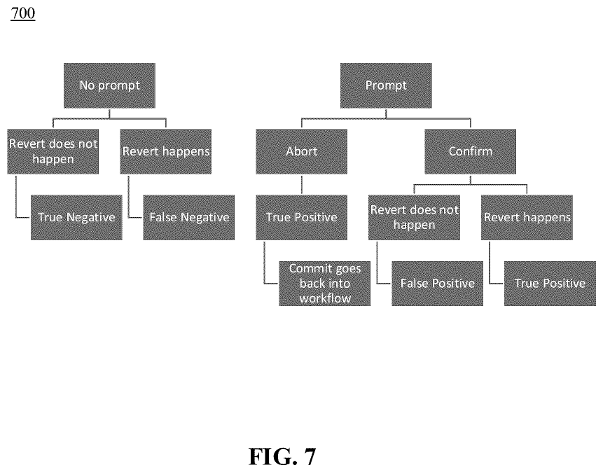

Monitoring: It is important to monitor the actions of the end user in order to better enhance the model. FIG. 7 is a diagram 700 that illustrates a set of potential results of monitoring a method for applying a machine learning model that uses an artificial intelligence technique to determine that a software code commit is risky and therefore likely to result in a production issue and to provide an explanation for the risk, according to an exemplary embodiment.

Referring to FIG. 7, in an exemplary embodiment, the monitoring module looks at whether or not the user was prompted, what the user selected (i.e., abort or confirm), and whether or not the revert happens within a timeboxed period, such as, for example, within 24 hours. Based on this, the monitoring module can follow any of the paths shown in diagram 700 in order to be assessed as a True Positive, which is predicted as a revert and revert actually happens; a True Negative, which is predicted as not being risky and no revert actually happens; a False Positive, which is predicted as a revert but no revert actually happens; or a False Negative, which is predicted as not being risky but a revert actually happens. Based on these four assessments, several performance metrics can be calculated. In an exemplary embodiment, precision and recall are calculated and monitored over time and if either of these falls under a certain threshold, then the entire model should be retrained.

In an exemplary embodiment, new code commits are regularly joining the archive of code commits and are therefore included in subsequent operations of retraining of the model.

In an exemplary embodiment, the models may be enhanced, and deep learning approaches, such as graph neural networks, may be used.

Accordingly, with this technology, an optimized process for applying a machine learning model that uses an artificial intelligence technique to determine that a software code commit is risky and therefore likely to result in a production issue and to provide an explanation for the risk is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for predicting a risky code commit, the method being implemented by at least one processor, the method comprising:
receiving, by the at least one processor, a first code commit;
analyzing, by the at least one processor, the first code commit in order to determine a plurality of features that relate to the first code commit;
applying, by the at least one processor, a machine learning model that uses an artificial intelligence technique to project a result of executing the first code commit;
assessing, by the at least one processor based on a result of the applying, whether the first code commit is risky; and
when the first code commit is assessed as being risky, determining an explanation that relates to the assessment of riskiness.

2. The method of claim 1, wherein the assessing of whether the first code commit is risky comprises detecting an anomaly with respect to at least one feature from among the plurality of features based on a result of the applying of the machine learning model.

3. The method of claim 2, wherein the assessing of whether the first code commit is risky further comprises calculating, for each respective feature from among the plurality of features, a corresponding ranking value, and detecting the anomaly based on each corresponding ranking value.

4. The method of claim 3, wherein the calculating of each corresponding ranking value comprises calculating a Shapley Additive explanations (SHAP) value of each respective feature from among the plurality of features.

5. The method of claim 1, further comprising displaying, via a user interface (UI), a textual message that includes the explanation.

6. The method of claim 5, wherein the textual message further includes at least one recommendation for performing an action in order to overcome the assessed riskiness.

7. The method of claim 5, further comprising displaying, via the UI, a first button for prompting a user to abort the first code commit and a second button for prompting the user to confirm the first code commit.

8. The method of claim 7, wherein when the user confirms the first code commit, the method further comprises prompting the user to input a justification for confirming the first code commit.

9. The method of claim 1, wherein the plurality of features includes at least one from among a number of lines of code, a number of files being changed, a number of first modules importing second modules being changed, a time interval between making the first code commit and progressing into production, a cyclomatic complexity, a number of times that the second modules have been reverted in a most recent 30-day period, a version of the second modules, and a number of developers who have contributed changes to the second modules.

10. A computing apparatus for predicting a risky code commit, the computing apparatus comprising:
a processor;
a memory;
a display; and
a communication interface coupled to each of the processor, the memory, and the display,
wherein the processor is configured to:
receive, via the communication interface, a first code commit;
analyze the first code commit in order to determine a plurality of features that relate to the first code commit;
apply a machine learning model that uses an artificial intelligence technique to project a result of executing the first code commit;
assess, based on a result of the application of the machine learning model, whether the first code commit is risky; and
when the first code commit is assessed as being risky, determine an explanation that relates to the assessment of riskiness.

11. The computing apparatus of claim 10, wherein the processor is further configured to perform the assessment of whether the first code commit is risky by detecting an anomaly with respect to at least one feature from among the plurality of features based on a result of the applying of the machine learning model.

12. The computing apparatus of claim 11, wherein the processor is further configured to perform the assessment of whether the first code commit is risky by calculating, for each respective feature from among the plurality of features, a corresponding ranking value, and detecting the anomaly based on each corresponding ranking value.

13. The computing apparatus of claim 12, wherein the processor is further configured to perform the calculation of each corresponding ranking value by calculating a Shapley Additive explanations (SHAP) value of each respective feature from among the plurality of features.

14. The computing apparatus of claim 10, wherein the processor is further configured to cause the display to display, via a user interface (UI), a textual message that includes the explanation.

15. The computing apparatus of claim 14, wherein the textual message further includes at least one recommendation for performing an action in order to overcome the assessed riskiness.

16. The computing apparatus of claim 14, wherein the processor is further configured to cause the display to display, via the UI, a first button for prompting a user to abort the first code commit and a second button for prompting the user to confirm the first code commit.

17. The computing apparatus of claim 16, wherein when the user confirms the first code commit, the processor is further configured to prompt the user to input a justification for confirming the first code commit.

18. The computing apparatus of claim 10, wherein the plurality of features includes at least one from among a number of lines of code, a number of files being changed, a number of first modules importing second modules being changed, a time interval between making the first code commit and progressing into production, a cyclomatic complexity, a number of times that the second modules have been reverted in a most recent 30-day period, a version of the second modules, and a number of developers who have contributed changes to the second modules.

19. A non-transitory computer readable storage medium storing instructions for predicting a risky code commit, the instructions comprising executable code which, when executed by a processor, causes the processor to:
receive a first code commit;
analyze the first code commit in order to determine a plurality of features that relate to the first code commit;
apply a machine learning model that uses an artificial intelligence technique to project a result of executing the first code commit;
assess, based on a result of the application of the machine learning model, whether the first code commit is risky; and
when the first code commit is assessed as being risky, determine an explanation that relates to the assessment of riskiness.

20. The storage medium of claim 19, wherein when executed by the processor, the executable code further causes the processor to perform the assessment of whether the first code commit is risky by detecting an anomaly with respect to at least one feature from among the plurality of features based on a result of the applying of the machine learning model.
